(19) United States
(12) Patent Application Publication
(10) Pub. No.: US 2010/0031084 A1
(43) Pub. Date: Feb. 4, 2010

(54) CHECKPOINTING IN A PROCESSOR THAT SUPPORTS SIMULTANEOUS SPECULATIVE THREADING

(75) Inventors: Marc Tremblay, Menlo Park, CA (US); Shailender Chaudhry, San Francisco, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/185,683

(22) Filed: Aug. 4, 2008

(51) Int. Cl. G06F 11/00

(52) U.S. Cl. 714/13; 714/E11.001

(57) ABSTRACT

Embodiments of the present invention provide a system for executing program code on a processor. In these embodiments, the processor is configured to start by using a primary strand to execute program code. Upon detecting a predetermined condition, the processor is configured to instantaneously checkpoint an architectural state of the primary strand and then use the subordinate strand to copy the checkpointed state to memory while using the primary strand to continue executing the program code without interruption.

### BACKGROUND

1. Field of the Invention

Embodiments of the present invention generally relate to the design of a processor in a computer system. More specifically, embodiments of the present invention facilitate checkpointing in a processor that supports simultaneous speculative threading.

2. Related Art

Some modern processors support checkpointing to save the precise architectural state of threads executing on the processor. For example, when generating a checkpoint, a processor can save a thread's architectural state information, including the thread's program counter (PC), next program counter (NPC), and one or more general-purpose registers, floating-point registers, condition-code registers, control/status registers, and/or state registers. If necessary, the thread can be subsequently returned to the checkpointed state by restoring the saved architectural state to the processor.

Unfortunately, in order to save a checkpoint to memory, conventional processors must cease to execute other instructions while the thread executes the instructions to save the checkpoint. Consequently, saving checkpoints can degrade the performance of the thread.

### SUMMARY

Embodiments of the present invention provide a system for executing program code on processor 102 (see FIG. 1). In these embodiments, the processor is configured to start by using a primary strand to execute program code. Upon detecting a predetermined condition, the processor is configured to instantaneously checkpoint an architectural state of the primary strand and then use a subordinate strand to copy the checkpointed state to memory while using the primary strand to continue executing the program code without interruption.

In some embodiments, the processor is configured to monitor the primary strand to detect errors associated with the primary strand after the checkpoint is generated. Upon detecting an error, the processor is configured to: (1) stop executing program code using the primary strand; (2) restore the checkpointed state of the primary strand (thereby returning the primary strand to the checkpointed state); and (3) resume execution of the program code using the primary strand.

In some embodiments, the processor is configured to determine if the checkpointed state is no longer useful. If so, the processor is configured to invalidate the checkpoint.

In some embodiments, the processor is configured to determine that the checkpointed state is no longer useful when: (1) one or more subsequent checkpoints have been generated; (2) one or more resources that are being used to hold the checkpointed state are required for subsequent operations; (3) a predetermined number of instructions have been executed; (4) a predetermined number of CPU clock cycles have passed; (5) a predetermined number of operations have occurred; or (6) a discrete COMMIT instruction has been encountered in the program code.

In some embodiments, the predetermined condition that causes the processor to generate a checkpoint includes at least one of: (1) a predetermined number of instructions having been executed; (2) a predetermined number of CPU clock cycles having occurred; (3) a predetermined number of entries in a store queue having been used; (4) a predetermined number of operations having occurred; (5) a trigger having been set; or (6) a checkpoint instruction having been encountered.

In some embodiments, when detecting that a trigger has been set, the processor is configured to detect a change or a predetermined value in one or more environment variables, files, global variables, hardware switches, processor registers, or other hardware or software values.

In some embodiments, the processor is configured to keep the subordinate strand idle when not using the subordinate strand to copy checkpoints for the primary strand to memory. In alternative embodiments, the processor is configured to use the subordinate strand to perform other computational work when not using the subordinate strand to copy checkpoints for the primary strand to memory.

In some embodiments, the processor is configured to retain the checkpointed state in memory as a record of the state of the primary strand at the corresponding time.

### BRIEF DESCRIPTION OF THE FIGURES

FIG. 1 presents a block diagram of a computer system in accordance with embodiments of the present invention.

FIG. 2 presents a block diagram of a set of R registers partitioned into a number of “register windows” in accordance with some embodiments of the present invention.

FIG. 3 presents a flowchart illustrating a process for checkpointing an architectural state of a primary strand using a checkpoint generating mechanism and using a subordinate strand to copy the checkpointed state to memory in accordance with embodiments of the present invention.

FIG. 4 presents a flowchart illustrating a process for invalidating a checkpoint for the primary strand in accordance with embodiments of the present invention.

FIG. 5 presents a flowchart illustrating a process for restoring a checkpoint for the primary strand in accordance with embodiments of the present invention.

FIG. 6 presents a timing diagram illustrating an interaction between a primary strand and a subordinate strand in accordance with embodiments of the present invention.

For a better understanding of the aforementioned embodiments of the present invention as well as additional embodiments thereof, reference should be made to the detailed description of these embodiments below, in conjunction with the figures, in which like reference numerals refer to corresponding parts throughout.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Terminology

The following description includes the terms “strand” and “thread.” Although these terms are known in the art, the following definitions are provided to clarify the subsequent description.

The term “thread” refers to a “thread of execution,” which is a software entity that can be run on hardware. For example, a computer program can be executed using one or more software threads.

A strand includes state information that is stored in hardware that is used to execute a thread. More specifically, a strand includes the software-visible architectural state of a thread, along with any other microarchitectural state required for the thread's execution. For example, a strand can include a program counter (PC), a next program counter (NPC), and one or more general-purpose registers, floating-point registers, condition-code registers, control/status registers, or state registers.

### Computer System

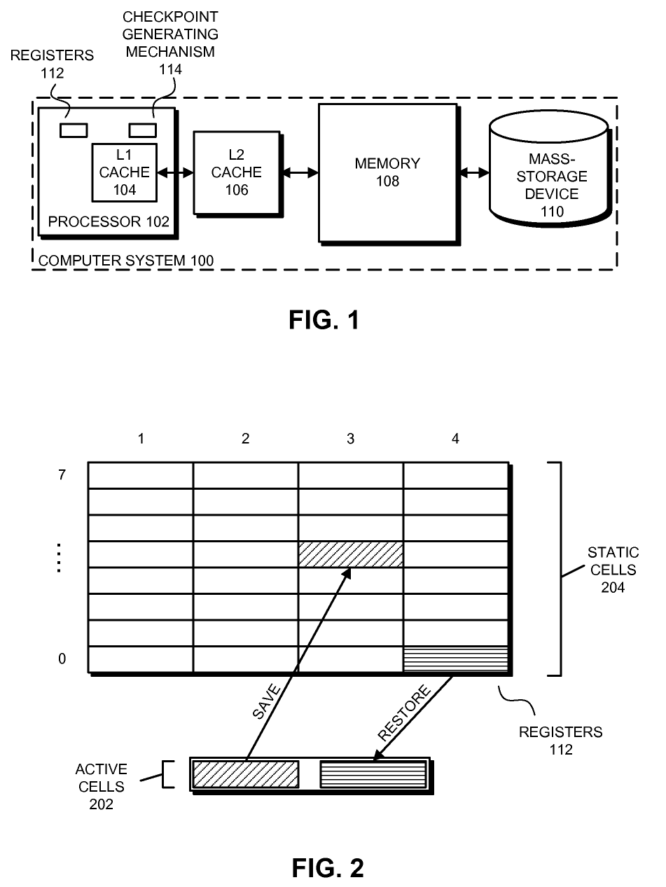

FIG. 1 presents a block diagram of a computer system 100 in accordance with embodiments of the present invention. Computer system 100 includes processor 102, L2 cache 106, memory 108, and mass-storage device 110.

Processor 102 can be a general-purpose processor that performs computational operations. For example, processor 102 can be a central processing unit (CPU), such as a microprocessor. Alternatively, processor 102 can be a controller or an application-specific integrated circuit. In embodiments of the present invention, processor 102 supports simultaneous speculative threading (SST), which is an operating mode wherein two or more strands are used to execute one thread. SST is described in more detail below.

Processor 102 includes L1 cache 104 and registers 112. Registers 112 include a number of processor registers that processor 102 uses to hold data during computational operations.

Mass-storage device 110, memory 108, L2 cache 106, and L1 cache 104 are computer-readable storage devices that collectively form a memory hierarchy that stores data and instructions for processor 102. Generally, mass-storage device 110 is a high-capacity, non-volatile storage device, such as a disk drive or a large flash memory, with a large access time, while L1 cache 104, L2 cache 106, and memory 108 are smaller, faster semiconductor memories that store copies of frequently used data. Memory 108 can be a dynamic random access memory (DRAM) structure that is larger than L1 cache 104 and L2 cache 106, whereas L1 cache 104 and L2 cache 106 can be comprised of smaller static random access memories (SRAM). Such memory structures are well-known in the art and are therefore not described in more detail.

Processor 102 also includes checkpoint generating mechanism 114 that can be used by processor 102 to instantly preserve a given strand's current architectural state (e.g., a PC/NPC, processor registers etc.) in a “shadow” architectural state in processor 102. Generating checkpoints (“checkpointing”) is described in more detail below.

Note that although we describe processor 102 as including a separate checkpoint generating mechanism 114, in some embodiments of the present invention, the operations performed by checkpoint generating mechanism 114 are performed by general-purpose circuits on processor 102. In these embodiments, the general-purpose circuits can be configured through hardware or software (e.g., instructions in program code) to perform these operations.

Computer system 100 can be incorporated into many different types of electronic devices. For example, computer system 100 can be part of a desktop computer, a laptop computer, a server, a media player, an appliance, a cellular phone, testing equipment, a network appliance, a calculator, a personal digital assistant (PDA), a hybrid device (e.g., a “smart phone”), a guidance system, a control system (e.g., an automotive control system), or another electronic device.

Although we use specific components to describe computer system 100, in alternative embodiments different components can be present in computer system 100. For example, computer system 100 can include video cards, network cards, optical drives, and/or other peripheral devices that are coupled to processor 102 using a bus, a network, or another suitable communication channel. Alternatively, computer system 100 may include one or more additional processors, wherein the processors share some or all of L2 cache 106, memory 108, and mass-storage device 110. On the other hand, computer system 100 may not include some of the memory hierarchy (i.e., L2 cache 106, memory 108, and/or mass-storage device 110).

Register Windows

FIG. 2 presents a block diagram of a set of R registers 112 partitioned into a number of “register windows” in accordance with some embodiments of the present invention. For each strand, processor 102 uses a subset (window) of the R registers 112 as a set of processor registers. In some embodiments, processor 102 holds a register window that is currently being used in active cell 202, while the remaining (inactive) register windows are stored in a static cell 204. Register windows are known in the art and hence are not described in more detail.

Generally, processor 102 can use a SAVE instruction to save the present register window (i.e., copy an active register window to an available static cell). Conversely, processor 102 can use a RESTORE instruction to restore a previous register window (i.e., copy the associated static cell to an active register window). In some embodiments of the present invention, the SAVE and RESTORE operations for a given register window are single-cycle operations, because the SAVE can be done by incrementing a current window pointer (CWP), while the RESTORE can be done by decrementing the CWP. The SAVE and RESTORE instructions and their interaction with the CWP are known in the art and hence are not described in more detail.

In embodiments of the present invention, the contents of a register window can also be written to memory (i.e., stored in one or more levels of the memory hierarchy). Writing the contents of the register window to memory can free up the register window to be used for subsequent operations.

Although we describe embodiments of the present invention that use a specific configuration of registers 112, alternative embodiments of the present invention use other arrangements of processor registers and/or register files.

### Simultaneous Speculative Threading

In embodiments of the present invention, processor 102 supports simultaneous speculative threading (SST), wherein two or more strands are used together to execute a single software thread. For example, these embodiments can use a “primary strand” and a “subordinate strand” to execute the thread.

In some embodiments of the present invention, processor 102 uses the primary strand to execute all of the program code for a software thread, while using the subordinate strand only to save checkpoints for the primary strand to memory. (Processor 102 uses checkpoint generating mechanism 114 to generate checkpoints, as described below.) In alternative embodiments, processor 102 uses the subordinate strand to perform other computational work when the subordinate strand is not being used to save checkpoints for the primary strand to memory. In these embodiments, processor 102 interrupts the subordinate strand from performing the other computational work to save a checkpointed state of the primary strand to memory.

Note that the designations “primary strand” and “subordinate strand” used in this description do not indicate a particular strand (i.e., any strand can function as a primary strand or a subordinate strand). In some embodiments, a strand can be switched between being a primary strand and a subordinate strand during processor 102's operation. Moreover, although we describe embodiments of the present invention that use two strands to execute one thread, alternative embodiments can use more than two strands. For example, some embodiments can use two or more strands together which collectively function as the primary strand or the subordinate strand.

Embodiments of the present invention can save checkpoints for the primary strand without interrupting the operation of the primary strand. More specifically, upon encountering the predetermined condition, checkpoint generating mechanism 114 can instantaneously save a copy of the architectural state of the primary strand. The subordinate strand can then save the copied architectural state in memory while the primary strand continues executing program code, so the primary strand is not obligated to stop executing instructions to save checkpoints. Consequently, these embodiments can save checkpoints in situations where saving checkpoints using existing systems could significantly degrade the existing system's performance. For example, these embodiments can use checkpointing mechanism 114 to generate a large number of checkpoints for the primary strand in a short period of time and while the subordinate strand saves the generated checkpoints to memory, which can keep the subordinate strand completely occupied while the primary strand continues executing program code without interruption. Note that in conventional systems (where the primary strand saves its own checkpoints to memory), the primary strand makes no progress in this type of situation because all the primary strand's resources are needed to save checkpoints (instead of executing the program code).

### Checkpointing

Embodiments of the present invention support using the subordinate strand to save checkpoints, which involves first using checkpoint generation mechanism 114 to preserve the precise architectural state of at least one thread on processor 102 and then saving the precise architectural state to memory (e.g., L1 cache 104) using the subordinate strand. (Note that checkpointing the state of a thread involves checkpointing the state of one or more strands that are being used to execute the thread.) The checkpointed state saved in memory can then be used to restore the thread to the checkpointed architectural state in the event that an error condition is detected. Alternatively, the checkpointed state saved in memory can function as a record of the architectural state of the thread/strand when the checkpoint was generated.

Generally, when generating a checkpoint, processor 102 uses checkpoint generating mechanism 114 to perform one or more operations to preserve the architectural state of processor 102. For example, processor 102 can save an underlying strand's PC/NPC, general-purpose registers, floating-point registers, condition-code registers, control/status registers, state registers, and/or other hardware or software values that can then be used to recover the checkpointed state. Processor 102 can also perform other operations, such as gating a store queue to prevent post-checkpoint stores from being committed to the architectural state until the checkpoint is invalidated (or used to recover the checkpointed state in the event of an error).

In some embodiments of the present invention, processor 102 uses checkpoint generating mechanism 114 to copy an original architectural state of the strand into a backup (or “shadow”) copy and then continues to use the original architectural state of the strand for writing new data. In these embodiments, some or all of the architectural state of the strand is captured in the separate shadow copy. In alternative embodiments, processor 102 uses checkpoint generation mechanism 114 to switch from an original copy of the architectural state to a “shadow” copy associated with the strand (i.e., switch to a back-up register file, PC etc.) for writing new data, thereby leaving the checkpointed state in the original copy of the architectural state.

In some embodiments of the present invention, checkpoint generating mechanism 114 can copy the current architectural state of a strand into a shadow copy of the architectural state in one cycle. In some of these embodiments, the shadow copy is maintained in parallel with the architectural state (i.e., a shadow PC is updated when the architectural PC is updated), so that the copy operation can occur in a single cycle. In alternative embodiments, the shadow state is only used to preserve the state changes after a copy operation, while the original state is remains preserved in the original architectural state (i.e., the shadow state may store only data that has changed since the copy operation).

Note that references to “instantly” generating checkpoints in this description refer to the generation of checkpoints where the copy operation is guaranteed to capture a consistent architectural state. In other words, in these embodiments, no checkpoints are generated wherein subsequent data corrupts the captured state. For example, the generation of the checkpoint can occur very quickly (as described above). Alternatively, processor 102 can include one or more locking mechanisms or other state-preserving mechanisms that enable the generation of a checkpoint to occur more slowly, but otherwise protect the architectural state from being overwritten by subsequent data.

In embodiments of the present invention that use register windows, when generating a checkpoint, processor 102 can save the processor registers in a current register window by using a SAVE instruction. In these embodiments, processor 102 can use a RESTORE instruction to restore the saved registers (i.e., re-activate the associated register window) in the event that the checkpoint must be restored. In some embodiments of the present invention, using the SAVE and RESTORE instructions (along with the CWP) to checkpoint the registers results in single-cycle register checkpointing.

In some embodiments of the present invention, processor 102 can use the subordinate strand save the checkpointed state into memory (e.g., to L1 cache 104, memory 108, or another level of the memory hierarchy). By saving the checkpointed state into memory (instead of holding the checkpointed state in registers 112), processor 102 facilitates saving a larger number of checkpointed states.

In some embodiments of the present invention, processor 102 supports multiple checkpoints. In other words, processor 102 can use checkpoint generating mechanism 114 to generate one or more additional checkpoints while one or more checkpoints already exist. The subsequent checkpoints preserve the architectural state of processor 102 and otherwise function in the same way as the checkpoints described above. In these embodiments, processor 102 includes mechanisms for distinguishing the checkpoints. For example, the store queue may include mechanisms for indicating that stores are associated with a particular checkpoint.

Generating Checkpoints

In some embodiments of the present invention, processor 102 can use checkpoint generating mechanism 114 to generate a checkpoint when a predetermined condition (e.g., a sequence of events or a then-extant condition in processor 102) indicates that a checkpoint may be useful. For example, processor 102 can generate a checkpoint upon detecting that a predetermined number of: (1) instructions have been executed; (2) CPU clock cycles have passed; (3) entries in the store queue have been used; or (4) operations have occurred (e.g., cache reads/writes, floating point operations, branches, etc.). In this way, processor 102 can periodically (and automatically) preserve the architectural state of processor 102 to facilitate efficient recovery from subsequent errors or as a record of the architectural state of processor 102.

In some embodiments of the present invention, processor 102 can use checkpoint generating mechanism 114 to generate a checkpoint in response to a trigger. More specifically, processor 102 can monitor one or more environment variables, files, global variables, or other modifiable values and/or hardware or software indicators to determine when a checkpoint should be generated.

In these embodiments, another entity (operating system, program, hardware checkpointing mechanism, etc.) or a human can control when the checkpoints are generated. For example, a human can determine that a setting of 2 million CPU clock cycles between checkpoints is too long and can adjust a value in a processor register or in an environment variable to reduce the number of clock cycles between checkpoints. Alternatively, a monitoring program that is monitoring the state of processor 102 while processor 102 executes program code can adjust a value in a control file to adjust the number of checkpoints that is generated.

In some embodiments of the present invention, a checkpoint can be generated upon encountering a discrete checkpoint instruction. In these embodiments, a programmer can manually insert a checkpoint instruction in the program code. Alternatively, during compilation of program code, a compiler can analyze the code and automatically insert checkpoint instructions in the program code.

Invalidating Checkpoints

In some embodiments of the present invention, a checkpoint can be invalidated when processor 102 performs a commit operation. Generally, a commit operation is used to update the architectural state with computational results that were produced after a checkpoint was generated, but kept separate to avoid corrupting the checkpointed architectural state (e.g., post-checkpoint stores held in the store queue). In these embodiments, the commit operation can be performed when processor 102 determines that the checkpoint is no longer useful. For example, processor 102 can determine that the checkpoint is no longer useful: (1) when a subsequent checkpoint has been generated; (2) in order to free up resources (e.g., when the store queue is full of gated stores); or when a predetermined number of instructions have been executed/CPU clock cycles have passed/operations have occurred since the checkpoint was generated. In alternative embodiments, processor 102 can perform the commit operation upon encountering a discrete COMMIT instruction in the program code.

When performing the commit operation, processor 102 can also commit post-checkpoint results to the architectural state of processor 102. For example, processor 102 can release the gate on the store queue to permit the stores to be completed to L1 cache 104 (and the rest of the memory hierarchy).

Recovering to the Checkpointed State

In some embodiments of the present invention, processor 102 can use the state preserved during the generation of a checkpoint for recovery in the event of an error. For example, when recovering from an error, processor 102 can stop executing instructions using the strand (which may involve flushing the pipeline and other operations), copy the preserved state back into the strand, and resume executing instructions using the strand from the restored PC. Note that recovering the checkpointed state can involve copying a checkpointed state from memory back to the appropriate strand on processor 102.

In some embodiments of the present invention, processor 102 uses the checkpoint to recover from errors that will not repeat upon re-executing the program code after the checkpoint. For example, such errors that will not repeat include a store queue full error, a memory model violation, or another such error, but not a divide-by-zero error that will repeat upon re-executing the instruction following the restoration of the checkpoint. Repeating errors, such as a divide-by-zero error, are handled using techniques known in the art.

### Checkpointing Process

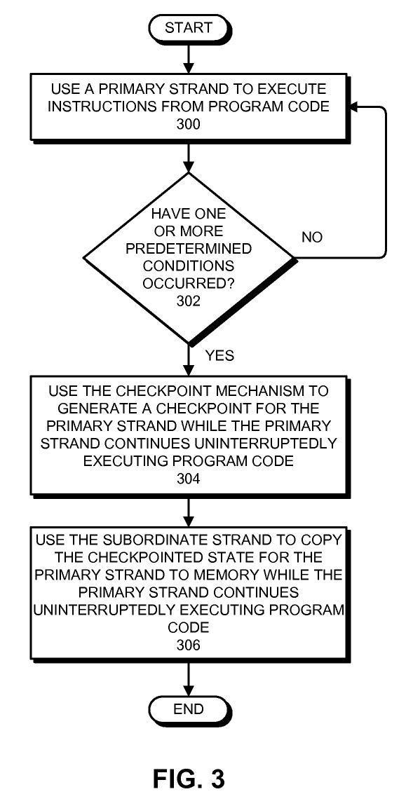

FIG. 3 presents a flowchart illustrating a process for checkpointing an architectural state of a primary strand using checkpoint generating mechanism 114 and using a subordinate strand to copy the checkpointed state to memory in accordance with embodiments of the present invention. The process starts with processor 102 using a primary strand to execute instructions from program code (step 300). In some embodiments of the present invention, while using the primary strand to execute program code, processor 102 holds the subordinate strand in an idle state. In alternative embodiments, while using the primary strand to execute program code, processor 102 uses the subordinate strand to perform other computational operations. In these embodiments, processor 102 interrupts the subordinate strand from the other computational operations to copy checkpoints (generated by checkpoint generating mechanism 114) from a shadow copy of the architectural state of the primary strand on processor 102 to memory (e.g., L1 cache 104).

While executing program code using the primary strand, processor 102 monitors the primary strand to determine if one or more predetermined conditions have occurred (step 302). For example, processor 102 can monitor one or more indicators such as environment variables, files, global variables, or other values to determine if there has been a change in one of the indicators or if the indicators equal a predetermined value. On the other hand, processor 102 can determine whether a predetermined number of: (1) instructions have been executed; (2) CPU clock cycles have passed; (3) entries in the store queue have been used; or (4) operations have occurred (e.g., cache reads/writes, floating point operations, branches, etc.) since a checkpoint was last generated. Alternatively, processor 102 can determine if a discrete checkpoint instruction has been encountered.

If no predetermined conditions have occurred, processor 102 returns to step 300 to continue to use the primary strand to execute instructions from program code for a thread. Otherwise, if a predetermined condition has occurred, processor 102 uses checkpoint generating mechanism 114 to generate a checkpoint for the primary strand while the primary strand continues executing program code without interruption (step 304). Generating the checkpoint for the primary strand using checkpoint generating mechanism 114 involves checkpoint generating mechanism 114 performing operations to preserve some or all of the primary strand's architectural state. For example, the subordinate strand can save the primary strand's PC/NPC, processor registers, control/status registers, etc., as well as performing other operations to ensure that the architectural state of the primary strand is preserved. For example, the subordinate strand can gate the store queue to prevent the primary strand from committing post-checkpoint stores until the checkpoint is invalidated (or is used to recover the checkpointed state). Note that in some embodiments of the present invention, generating the checkpoint occurs instantaneously, which means that checkpoint generating mechanism 114 captures the architectural state for the primary strand in a consistent state (i.e., before subsequent data is written into the architectural state by processor 102).

Processor 102 then uses the subordinate strand to copy the checkpointed state for the primary strand to memory while the primary strand continues executing program code without interruption (step 306). For example, processor 102 can use the subordinate strand to copy the checkpointed state to L1 cache 104, L2 cache 106, or another level of the memory hierarchy.

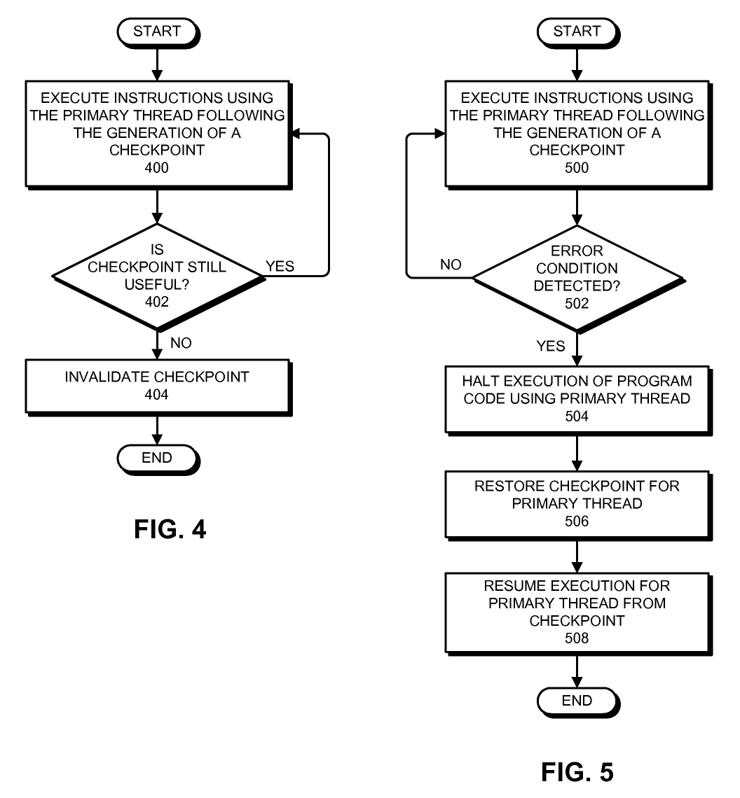

FIG. 4 presents a flowchart illustrating a process for invalidating a checkpoint for the primary strand in accordance with embodiments of the present invention. The process in FIG. 4 starts with the primary strand executing instructions following the generation of a checkpoint (step 400). As described above, in some embodiments of the present invention, the subordinate strand is idle while the primary strand executes instructions. In other embodiments, the subordinate strand is performing other computational operations.

While the primary strand executes instructions, processor 102 monitors the primary strand to determine if the checkpoint is still useful (step 402). Generally, the checkpoint remains useful if there remains a chance that processor 102 will use the checkpoint to restore the primary thread to the checkpointed state (e.g., if the primary thread can still encounter an error necessitating the return to the checkpointed state) or will use the checkpointed state for another purpose (e.g., as a record of the architectural state of processor 102 at the point that the checkpoint was generated). For example, processor 102 can determine that the checkpoint is no longer useful: (1) when a subsequent checkpoint has been generated; (2) in order to free up resources (e.g., when the store queue is full of gated stores); (3) when a predetermined number of instructions have been executed, CPU clock cycles have passed, or operations have occurred since the checkpoint was generated; or (4) when the checkpoint is no longer needed as a record of the checkpointed architectural state. In alternative embodiments, processor 102 can determine that the checkpoint is no longer useful upon encountering a discrete COMMIT instruction in the program code.

If the checkpoint is still useful, processor 102 returns to step 400 to execute instructions using the primary strand. Otherwise, processor 102 invalidates the checkpoint (step 404). In some embodiments of the present invention, invalidating a checkpoint can involve deleting the checkpoint from memory and/or from the shadow copy on processor 102. In some of these embodiments, when invalidating the checkpoint processor 102 uses the subordinate strand to invalidate and/or delete the checkpoint, thereby enabling the primary strand to continue uninterruptedly executing program code.

FIG. 5 presents a flowchart illustrating a process for restoring a checkpoint for the primary strand in accordance with embodiments of the present invention. The process in FIG. 5 starts with the primary strand executing instructions following the generation of a checkpoint (step 500). As described above, in some embodiments of the present invention, the subordinate strand is idle while the primary strand executes instructions. In other embodiments, the subordinate strand is performing other computational operations.

While the primary strand executes instructions, processor 102 monitors the primary strand to determine if an error condition has occurred for the primary strand (step 502). If no error condition is detected, processor 102 returns to step 500 to execute instructions using the primary strand. Otherwise, an error has occurred for the primary strand and processor 102 restores the checkpoint to enable the primary strand to re-execute the program code before the error.

When restoring the checkpoint, processor 102 starts by stopping execution of the program code using the primary strand (step 504). Processor 102 then restores the checkpoint for the primary strand (step 506). Restoring the checkpoint involves copying some or all of the checkpointed state back into the primary strand (and other areas in processor 102 or computer system 100, if necessary to restore the checkpointed state). Note that copying some or all of the checkpointed state can involve copying some or all of the state back to processor 102 from memory. In some embodiments of the present invention, processor 102 uses the primary strand to restore the checkpoint. In other embodiments, processor 102 uses the subordinate strand. Processor 102 then resumes execution from the checkpoint (i.e., the checkpointed PC) using the primary strand (step 508).

### Interactions Between Strands

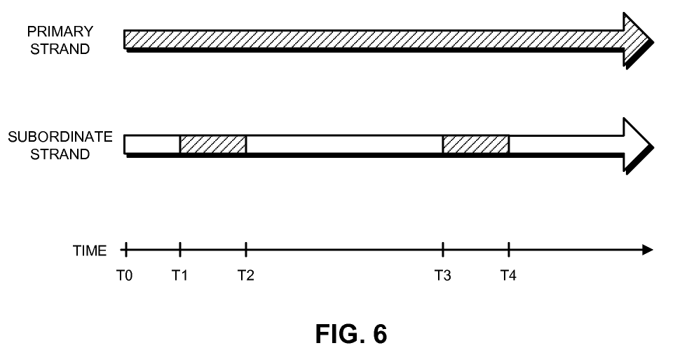

FIG. 6 presents a timing diagram illustrating an interaction between a primary strand and a subordinate strand in accordance with embodiments of the present invention. In the diagram, the primary strand executes program code for a thread, while the subordinate strand copies checkpoints for the primary strand to memory. In FIG. 6, each strand is represented by a thick arrow. Periods when a strand is active (i.e., performing computational work) are indicated by hash-marks, whereas periods when a strand is idle are indicated by a solid background.

Note that we present an example where the subordinate strand is idle when not generating checkpoints for the primary strand. However, in some embodiments of the present invention, the subordinate strand can perform other computational work when not copying checkpoints for the primary strand to memory.

At time T0 in FIG. 6, the primary strand is executing program code while the subordinate strand is idle. While the primary strand executes program code, processor 102 monitors the progress of the primary strand. For example, processor 102 can keep track of the number of instructions executed by the primary strand, the number of available queue slots in a store queue, or any of a number of other hardware and/or software “progress indicators.” Processor 102 monitors these progress indicators to determine when to generate a checkpoint to preserve the architectural state of the primary strand. For example, processor 102 can generate a checkpoint when a predetermined number of instructions have been executed by the primary strand.

At time T1, processor 102 determines that a checkpoint should be generated for the primary strand. Processor 102 therefore uses checkpoint generating mechanism 114 to generate the checkpoint. Processor 102 then awakens the subordinate strand from the idle state to copy the checkpointed state to memory, wherein copying the checkpointed state causes the subordinate strand to be active from time T1 to T2. Recall that when generating the checkpoint, checkpoint generating mechanism 114 checkpoints the state of the primary strand, which can include saving the current state of the primary strand's PC, processor registers, status/control registers, etc., as well as performing other operations, such as gating the store queue for stores generated by the primary strand. After copying the checkpoint to memory, processor 102 returns the subordinate strand to the idle state.

At time T3, processor 102 again determines that a checkpoint should be generated for the primary strand and uses checkpoint generating mechanism 114 to generate a checkpoint. Processor 102 then awakens the subordinate strand from the idle state to copy the checkpoint to memory, which causes the subordinate strand to be active from time T3 to T4.

Note that this example provides a description of embodiments of the present invention wherein two checkpoints can be active simultaneously in processor 102, as well as copied to memory using the subordinate strand (i.e., a checkpoint can exist in a shadow state on processor 102 and a copy of the checkpoint can be stored in memory).

### ALTERNATIVE EMBODIMENTS

As described above, processor 102 can use a primary strand to execute program code while using a subordinate strand to copy checkpoints to memory, thereby preserving the architectural state of processor 102 without degrading the performance of the primary strand. In some embodiments of the present invention, this functionality can be used for debugging the program code.

More specifically, during a debugging process, a debugging entity (i.e., a human debugger or a debugging application) can determine an approximate location in the program code where an error occurs. The debugging entity can then cause checkpoint generating mechanism 114 to generate multiple checkpoints near the determined location (thereby preserving multiple sequential copies of the architectural state of processor 102). For example, assuming that an environment variable (which is used to control processor 102) causes processor 102 to use checkpoint generating mechanism 114 to generate checkpoints, the debugging entity can adjust the value of the environment variable to increase the frequency at which checkpoint generating mechanism 114 generates checkpoints. Processor 102 can then use the subordinate strand to copy each checkpoint to memory, thereby freeing space in the shadow state for checkpoint generating mechanism 114 to store a subsequent checkpoint.

In these embodiments, writing the checkpoint (i.e., the preserved architectural state) to memory after each checkpoint enables processor 102 to capture a sequence of “snapshots” of the architectural state of the primary strand in a short time near the location where the error occurs. Using the snapshots and a trace of the instructions in the target program code, the debugging entity can identify where an error originated.

In contrast to existing systems which use breakpoints, these embodiments are not required to interrupt the primary strand's execution of the program code. In addition, these embodiments can facilitate a programmer observing when an error condition originates (as compared to when the error condition finally causes the program to fail). Consequently, debugging can be more efficient and more accurate.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for executing program code on a processor, comprising:
executing program code using a primary strand;
upon detecting a predetermined condition, instantaneously checkpointing an architectural state of the primary strand while using the primary strand to continue executing the program code without interruption; and
using a subordinate strand to copy the checkpointed state in a memory while using the primary strand to continue executing the program code without interruption.

2. The method of claim 1, wherein the method further comprises:
detecting an error associated with the primary strand after generating the checkpoint;
stopping executing program code using the primary strand;
restoring the checkpointed state of the primary strand, thereby returning the primary strand to the checkpointed state; and
resuming execution of the program code using the primary strand.

3. The method of claim 1, wherein the method further comprises:
determining whether the checkpointed state is no longer useful; and
invalidating the checkpoint when the checkpointed state is no longer useful.

4. The method of claim 3, wherein the checkpointed state is no longer useful when at least one of:
one or more subsequent checkpoints have been generated;
one or more resources that are being used to hold the checkpointed state are required for subsequent operations;
a predetermined number of instructions have been executed;
a predetermined number of CPU clock cycles have passed;
a predetermined number of operations have occurred; or
a discrete COMMIT instruction has been encountered in the program code.

5. The method of claim 1, wherein the predetermined condition includes at least one of:
a predetermined number of instructions having been executed;
a predetermined number of CPU clock cycles having occurred;
a predetermined number of entries in a store queue having been used;
a predetermined number of operations having occurred;
a trigger having been set; or
a checkpoint instruction having been encountered.

6. The method of claim 5, wherein detecting that a trigger has been set involves detecting a change or a predetermined value in one or more environment variables, files, global variables, hardware switches, processor registers, or other hardware or software values.

7. The method of claim 1, wherein the subordinate strand is idle or is performing other computational work when not being used to copy a checkpoint to memory for the primary strand.

8. The method of claim 1, wherein the method further comprises retaining the checkpointed state in memory as a record of the state of the primary strand at a corresponding time.

9. An apparatus for executing program code, comprising:
a processor;
a checkpoint generating mechanism in the processor;
a memory coupled to the processor, wherein the memory is configured to store data for the processor;
wherein the processor is configured to execute program code using a primary strand; and
upon detecting a predetermined condition, the processor is configured to:
use the checkpoint generating mechanism to instantaneously checkpoint an architectural state of the primary strand while using the primary strand to continue executing the program code without interruption; and
use a subordinate strand to copy the checkpointed state to the memory while using the primary strand to continue executing the program code without interruption.

10. The apparatus of claim 9, wherein the processor is configured to:
monitor the primary strand while the primary strand executes program code after the checkpoint generating mechanism has checkpointed the architectural state to determine if the primary strand has encountered an error;
if the processor determines that the primary strand has encountered an error, the processor is configured to:
stop executing program code using the primary strand;
restore the checkpointed state of the primary strand, thereby returning the primary strand to the checkpointed state; and
resume execution of the program code using the primary strand.

11. The apparatus of claim 9, wherein the processor is configured to:
determine whether the checkpointed state is no longer useful; and
invalidate the checkpoint when the checkpointed state is no longer useful.

12. The apparatus of claim 11, wherein the checkpointed state is no longer useful when at least one of:
one or more subsequent checkpoints have been generated;
one or more resources that are being used to hold the checkpointed state are required for subsequent operations;
a predetermined number of instructions have been executed;
a predetermined number of CPU clock cycles have passed;
a predetermined number of operations have occurred; or
a discrete COMMIT instruction has been encountered in the program code.

13. The apparatus of claim 9, wherein the predetermined condition includes at least one of:
a predetermined number of instructions having been executed;
a predetermined number of CPU clock cycles having occurred;
a predetermined number of entries in a store queue having been used;
a predetermined number of operations having occurred;
a trigger having been set; or
a checkpoint instruction having been encountered.

14. The apparatus of claim 13, wherein when detecting that a trigger has been set, the processor is configured to detect a change or a predetermined value in one or more environment variables, files, global variables, hardware switches, processor registers, or other hardware or software values.

15. The apparatus of claim 9, wherein when not using the subordinate strand to copy a checkpoint to memory for the primary strand, the processor is configured to either keep the subordinate strand idle or use the subordinate strand to perform other computational work.

16. The apparatus of claim 9, wherein the processor is configured to retain the checkpointed state in memory as a record of the state of the primary strand at a corresponding time.

17. A computer system for executing program code, comprising:
a processor;
a memory coupled to the processor, wherein the memory is configured to store data for the processor;
a mass-storage device coupled to the processor and the memory, wherein the mass-storage device is configured to store data for the processor;
a checkpoint generating mechanism in the processor;
wherein the processor is configured to execute program code using a primary strand; and
upon detecting a predetermined condition, the processor is configured to:
use the checkpoint generating mechanism to instantaneously checkpoint an architectural state of the primary strand while using the primary strand to continue executing the program code without interruption; and
use a subordinate strand to copy the checkpointed state to the memory while using the primary strand to continue executing the program code without interruption.

18. The computer system of claim 17, wherein the processor is configured to:
monitor the primary strand while the primary strand executes program code after the checkpoint generating mechanism has checkpointed the architectural state to determine if the primary strand has encountered an error;
if the processor determines that the primary strand has encountered an error, the processor is configured to:
stop executing program code using the primary strand;
restore the checkpointed state of the primary strand, thereby returning the primary strand to the checkpointed state; and
resume execution of the program code using the primary strand.

19. The computer system of claim 17, wherein the processor is configured to:
determine whether the checkpointed state is no longer useful; and
invalidate the checkpoint when the checkpointed state is no longer useful.

20. The computer system of claim 17, wherein the processor is configured to:
write the checkpointed state to the memory; and
retain the checkpointed state in the memory as a record of the state of the primary strand at a corresponding time.
